(19) United States
(12) Patent Application Publication
(10) Pub. No.: US 2009/0319291 A1
(43) Pub. Date: Dec. 24, 2009

(54) SYSTEMS AND METHODS FOR PROVIDING A SELF-SERVICE MECHANISM FOR OBTAINING ADDITIONAL MEDICAL OPINIONS BASED ON DIAGNOSTIC MEDICAL IMAGES

(75) Inventors: Allan Noordvyk, Surrey (CA); Joe Biegel, Vancouver (CA); Catherine Forrester, Vancouver (CA)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: McKesson Financial Holdings Limited

(21) Appl. No.: 12/141,672

(22) Filed: Jun. 18, 2008

(51) Int. Cl. G06Q 50/00

(52) U.S. Cl. 705/2

(57) ABSTRACT

An apparatus and system are provided for facilitating a mechanism in which a patient or another person may utilize a system to request an independent second or subsequent read and a second or subsequent opinion relating to medical images that were provided by a previous physician. The apparatus and system also enable physicians desiring to provide second or subsequent reads and evaluations of medical images to be able receive payment for their services. The apparatus includes a processor configured to receive a medical image(s) and associated data initially evaluated by a previous physician and assign or select a physician identified in a list to provide a second or subsequent read of the medical images and associated data. The processor is capable of evaluating and sending the medical images and associated data to a first device and generating a second or subsequent medical opinion or diagnosis regarding the medical images.

### TECHNOLOGICAL FIELD

Embodiments of the invention relate generally to systems and methods for providing people with a mechanism by which to obtain a quality second opinion or diagnosis regarding one or more medical images and to provide a mechanism by which health care professionals performing the second opinion can be paid for their services.

### BACKGROUND OF THE INVENTION

Currently, the health care industry benefits from medical imaging which is often used by radiologists and other physicians to generate images of the human body or one or more parts of the human body for clinical purposes such as revealing or diagnosing a disease. Oftentimes, a radiologist or the like analyzes and interprets the images of the human body to aid in the diagnosis or prognosis of a disease with respect to a particular patient. Given the importance of the diagnosis to a patient's health, patients frequently desire to obtain a second opinion or a second diagnosis pertaining to the medical images of their body or parts thereof.

However, in recent times it is difficult for a patient or consumer to find a source of and manage the logistics for obtaining a quality second opinion regarding a diagnostic read of a previously performed imaging study that may have a material impact to their health and well-being. The problem or difficulty with a patient or consumer obtaining a quality second opinion regarding medical images has persisted since radiology, cardiology and other diagnostic practices have existed, i.e., since the early part of the twentieth century.

Typically, the present practice is for a patient or consumer to request a referral of a second radiologist, cardiologist or the like from his/her existing health care provider such as his/her primary health care physician in order to obtain a second opinion/diagnosis regarding medical images. Alternatively, a patient or consumer may obtain their medical images (or the images of a family member for example) and associated medical records from the health care institution that generated the medical images and provide them to one or more physicians that they identified themselves so that one of these self-identified physicians can provide a second opinion regarding the medical images. However, most patients or consumers do not know how to find a radiologist, cardiologist or the like that is qualified to interpret a medical image as well as a particular imaging procedure and are not prepared to negotiate the process of requesting images on physical media from the originating institution (e.g., hospital) that can be utilized by the radiologist, cardiologist or the like in performing the second opinion. Furthermore, no simple scheme exists in conventional insurance programs or the like for allowing the second imaging physician to charge for services in analyzing the medical images. Typically, this leaves the second imaging physician either providing the service without pay, i.e., pro bono, or the patient/consumer and the second imaging physician negotiating some ad hoc payment mechanism. In many cases, seeking and obtaining another physician to provide a second opinion results in a secondary examination of the patient which, in addition to being unnecessary, costly and inconvenient, may expose the patient to needless additional ionizing radiation.

Thus, a need exists to provide a more efficient way for patients or consumers to obtain a quality second diagnosis of a previously generated medical image as well as a manner in which to provide physicians with a mechanism that will exude confidence that they will be paid for their time and services in performing these second (or additional) diagnoses.

### BRIEF SUMMARY OF THE INVENTION

Exemplary embodiments of the invention provide a mechanism in which a patient or any other person may utilize a system to request a qualified independent second or subsequent read of previously generated medical images and a second or subsequent opinion/diagnosis relating to medical images and a corresponding opinion/diagnosis that was provided by a previous physician. Moreover, the exemplary embodiments of the invention enable physicians such as for example radiologists, cardiologists and the like that desire to provide second or subsequent reads and evaluations of medical images to be able to do so with the confidence that they will be paid for their time, expertise and efforts. At the same time, patients or others may utilize the system to become more knowledgeable about their potential health care options and feel more confident about the status of the health care condition and the appropriate course of action to take.

For instance, the exemplary embodiments of the invention may utilize a website which provides a convenient service that may match people such as patients for example who had a previous examination with a radiologist and received a corresponding opinion/diagnosis regarding the previous examination to another physician that is willing to read the medical images of one or more anatomical parts of the human body and a corresponding report associated with the previous examination and provide a second or subsequent opinion/diagnosis regarding the medical images.

The system of the exemplary embodiments is of particular benefit to patient's, legal guardian's of patients and any other person or entity because many people may not be comfortable with finding a qualified physician to provide a second or subsequent opinion/diagnosis pertaining to one or more medical images of anatomical parts of the human body, especially if the medical images and associated opinions/diagnoses of a physician corresponds to a potential life-changing situation. Also, if the opinion/diagnosis of a previous physician relates to a potential serious or life-changing event, a person such as a patient may not feel comfortable relying on a single physician's opinion.

In one exemplary embodiment a corresponding method and computer program product are provided. The method and computer program product may include receiving one or more medical images and associated data that was initially evaluated by a previous medical care provider and assigning or selecting a medical care provider from among one or more candidate medical care providers identified as being willing to provide a second or subsequent reading of the medical images and associated data. The method and computer program product also include sending the medical images and associated data to a first device that is associated with the selected medical care provider for evaluation. Additionally, the method and computer program product includes receiving a second or subsequent medical opinion or diagnosis regarding the medical images based upon an evaluation of the medical images and associated data by the selected medical care provider.

In yet another exemplary embodiment, an apparatus is provided for receiving a second or subsequent read and opinion/diagnosis regarding one or more medical images. The apparatus may include a processing element configured to receive one or more medical images and associated data that was initially evaluated by a previous medical care provider and assign or select a medical care provider from among one or more candidate medical care providers identified as being willing to provide a second or subsequent read of the medical images and associated data. The processing element is also configured to send the medical images and associated data to a first device, that is associated with the selected medical care provider, and evaluate the medical images and associated data. Also the processing element is configured to receive a second or subsequent medical opinion or diagnosis regarding the medical images based upon an evaluation of the medical images and associated data by the selected medical care provider.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic block diagram of an electronic device according to an exemplary embodiment of the invention;

FIG. 2 is a schematic block diagram of a system according to an exemplary embodiment of the invention;

FIGS. 3 & 4 illustrate various aspects of a website hosted and operated by a network entity according to an exemplary embodiment of the invention; and

FIG. 5 illustrates a flowchart for receiving a second or subsequent read and opinion/diagnosis regarding medical images.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

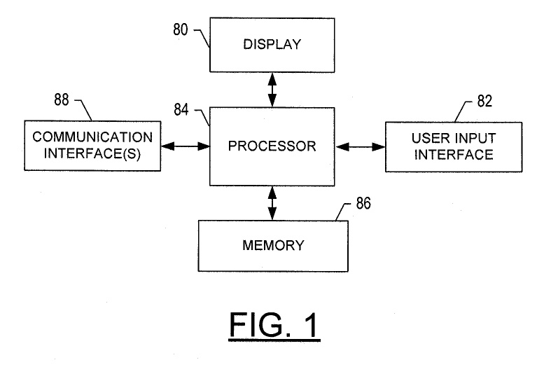

FIG. 1 illustrates a block diagram of an electronic device such as a client, server, computing device (e.g., personal computer (PC), computer workstation, laptop computer, personal digital assistant, etc.) or the like that would benefit from embodiments of the invention. The electronic device includes various means for performing one or more functions in accordance with exemplary embodiments of the invention, including those more particularly shown and described herein. It should be understood, however, that one or more of the electronic devices may include alternative means for performing one or more like functions, without departing from the spirit and scope of the invention. More particularly, for example, as shown in FIG. 1, the electronic device can include a processor 84 connected to a memory 86. The memory can comprise volatile and/or non-volatile memory, and typically stores content, data or the like. For example, the memory may store content transmitted from, and/or received by, the electronic device. The memory is capable of storing data including but not limited to medical data such as medical images or X-rays of the human body or one or more parts of the human body as well as diagnoses, opinions, laboratory results, measurements, patient prescriptions, or the like. Some of the diagnoses, opinions, laboratory results, measurements or the like may relate to or be associated with the medical images. The medical images described herein may be generated with the use of non-ionizing radiation, electromagnetic energy emitted by X-rays, ultrasound technology, magnetic resonance imaging or any other suitable mechanism or modality to view anatomical parts of the human body or animals. The medical images described herein may be formatted in accordance with the digital imaging and communications in medicine (DICOM) protocol which is a standard for storing handling, printing, receiving and transmitting information in medical imaging.

Also for example, the memory typically stores client applications, instructions or the like for executing the processor 84 to perform steps associated with operation of the electronic device in accordance with embodiments of the present invention. As explained below, for example, the memory can store one or more client application(s) such as for example software associated with the generation of medical data as well as handling and processing of one or more medical images.

The electronic device can include one or more logic elements for performing various functions of one or more client application(s). The logic elements performing the functions of one or more client applications can be embodied in an integrated circuit assembly including one or more integrated circuits integral or otherwise in communication with a respective network entity (i.e., computing system, client, server, etc.) or more particularly, for example, a processor 84 of the respective network entity.

In addition to the memory 86, the processor 84 can also be connected to at least one interface or other means for displaying, transmitting and/or receiving data, content or the like. The interface(s) can include at least one communication interface 88 or other means for transmitting and/or receiving data, content or the like. In this regard, the communication interface 88 may include, for example, an antenna and supporting hardware and/or software for enabling communications with a wireless communication network. For example, the communication interface(s) can include a first communication interface for connecting to a first network, and a second communication interface for connecting to a second network. In this regard, the electronic device is capable of communicating with other electronic devices over a network such as a Local Area Network (LAN), Wide Area Network (WAN), Wireless Wide Area Network (WWAN), the Internet, or the like. Alternatively, the communication interface can support a wired connection with the respective network. In addition to the communication interface(s), the interface(s) can also include at least one user interface that can include one or more earphones and/or speakers, a display 80, and/or a user input interface 82. The display 80 is capable of displaying information including but not limited to medical data. In this regard, the display is capable of showing one or more medical images which may consist of images or x-rays of the human body or one or more parts thereof as well as the results of diagnoses, medical opinions, medical tests and any other suitable data including but not limited to web pages associated with one or more websites. The user input interface, in turn, can comprise any of a number of devices allowing the entity to receive data from a user, such as a microphone, a keypad, keyboard, a touch display, a joystick, image capture device, pointing device (e.g., mouse), stylus or other input device.

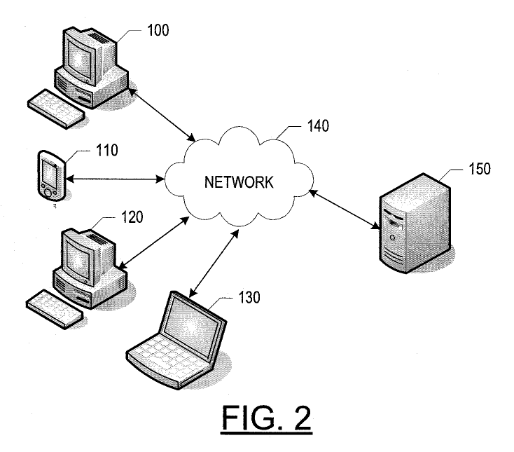

Reference is now made to FIG. 2, which is a block diagram of an overall system that would benefit from exemplary embodiments of the invention. It should be pointed out that one or more of the components of FIG. 2 may comprise the elements of the electronic device illustrated in FIG. 1. As shown the system may include one or more electronic devices 100, 110, 120, 130 (e.g., personal computers, laptops, personal digital assistants and the like) which may be operated by consumers, patients, physicians (e.g., radiologist, cardiologist, etc.) and one or more health care institutions (e.g., hospitals, clinics, etc.) or the like in order to access a server 150, or similar network entity, over a network 140, such as a wired or wireless local area network (LAN), a metropolitan network (MAN) and/or a wide area network (WAN) (e.g., the Internet). While four electronic devices 100, 110, 120 and 130 are shown in FIG. 2, it should be pointed out that any suitable number of electronic devices may be part of the system of FIG. 2. The server 150 may maintain and operate a secure site such as a website. In this regard, the server 150, via the site, is capable of receiving medical images and associated diagnoses, treatment recommendations, measurements and physician's comments regarding the medical images from any of electronic devices 100, 110, 120 and 130 and the processor 84 of the server 150 is capable of storing this data in a memory of the server 150. For instance, a clinic or other institution (e.g., hospital) operating one of the electronic devices may utilize the site to send or upload one or more medical images of a patient (when requested or authorized to do so by the patient or the patient's legal guardian) to the server 150 on behalf of the physician that analyzed the medical images and provided an opinion or diagnosis on the basis of the medical images generated by the clinic. Alternatively, a patient or another person (also referred to herein as subscriber) such as the patient's legal guardian may operate one of the electronic devices and utilize the site to send or upload medical images to the server 150. In this regard, when the subscriber has the medical images in his/her possession, the subscriber may utilize the site to send or upload the images to the server 150 by retrieving the medical images from any suitable form of physical storage media including but not limited to a compact disc (CD), a memory stick, a Digital Versatile Disc (DVD), a floppy disk or the like. When the medical images and associated diagnosis, measurements and physician's comments are received by the server 150, the processor 84 may store this data in a memory such as memory 86.

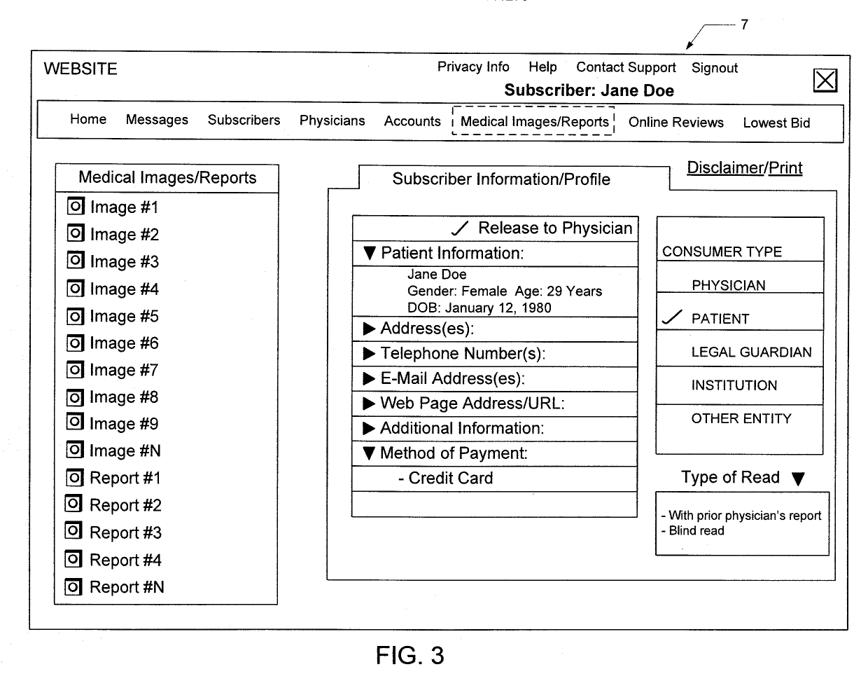

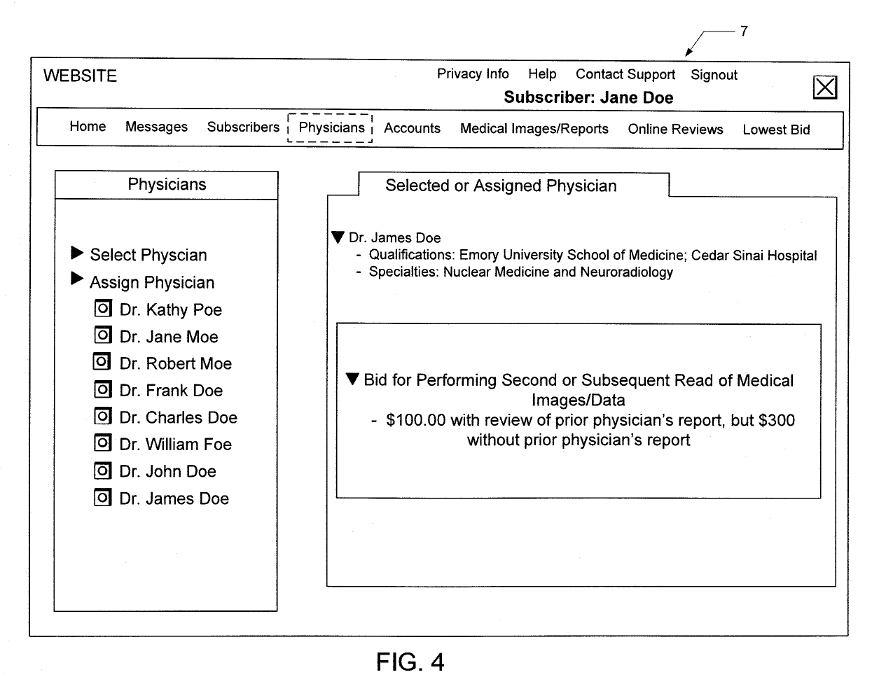

Referring now to FIG. 3 is an illustration of a site, namely a website, according to an exemplary embodiment of the invention. The website 7 may be maintained and operated by the processor 84 of the server 150. Utilizing the website, a patient, patient's legal guardian, or other consumer (i.e., a user), physician (e.g., radiologist) or institution (e.g., Radiology Department of a Hospital) may register with the website by generating a profile and creating a username and password for example as well as providing relevant contact information including but not limited to the name of the person/institution, one or more telephone numbers, mailing and physical address(es), e-mail address(es), any uniform resource locators (URLs) of related websites of the person/institution and any other suitable information. The profile may also include information indicating one or more anatomical parts of the human body which are included in one or more medical images that may be sent to the server 150. For instance, a patient, patient's legal guardian, consumer, physician, institution or any other suitable entity (also referred to herein as subscriber) planning to send or upload to the server one or more medical images of lungs, the brain, the heart or breasts or any other body part may specify in the profile that the images contain visual representations of the particular anatomical body part(s). Additionally, the profile may include information, content, data, etc. indicating a method of payment that the subscriber wishes to utilize for payment of a physician's second or subsequent reading and opinion/diagnosis pertaining to medical images and associated data as shown in FIG. 3. For instance, the subscriber may indicate in the profile that payment is to be made by credit card, debit card, PayPal™ account or any other suitable payment mechanism. The profile may be stored in a memory such as memory 86.

Additionally, each physician registering and subscribing to the website may include information in their profile relating to their qualifications, board certifications as well as specialty areas such as specialty areas in radiology, for example, where they graduated from medical school, states in which they are licensed, hospitals with which they are affiliated, journals, publications or other publications that they have authored or co-authored or any other suitable information. For example, a physician may include information in his/her profile indicating a specialty in diagnostic radiology, chest radiology, abdominal and pelvic radiology, neuroradiology, musculosketal radiology, pediatric radiology, mammography radiology, nuclear medicine, and any other suitable specialty areas. By registering with the website, each physician indicates his/her interest in providing second opinions and/or diagnoses in response to medical images of one or more parts of the human body and associated opinions and/or diagnoses related thereto that were provided by a previous physician.

When a subscriber is signed in to the website, and is in possession of medical images and associated reports, medical opinions, annotations, measurements or other information related to the medical images such as a diagnosis (also referred to herein as associated data) performed by a prior physician or other medical care provider that are stored on a physical storage medium, the subscriber, who may be the patient or the patient's legal guardian for example, can send or upload the medical images and associated data, to the server 150 in the manner discussed above. On the other hand, if the subscriber does not have the medical images in his/her possession, he/she can request or authorize the institution (e.g., hospital or clinic) that possesses the medical images to send or upload the medical images and associated data to the server 150, as described above. In this regard, the institution can send the medical images and associated data to an e-mail address associated with the website or alternatively, the institution may register with the website by creating a username and a password and a corresponding profile in the manner discussed above and can utilize the website to send or upload the medical images and associated data to the server 150, in which case the processor of the server receives the medical images and associated data and stores the medical images in its memory. These medical images may be in the DICOM format and the associated data may conform to the HL7 protocol and may be analyzed and evaluated by the processor of the server 150. In this regard, the processor of the server may properly index and store the images.

The processor 84 of the server 150 is able to read data or information in the profile of the patient, patient's legal guardian, consumer, physician, institution or other entity which indicates the anatomical body part(s) that is visually represented in the medical images and the processor is capable of analyzing the data in the profiles of all of the physicians that are registered with the website to identify one or more physicians that is qualified to read the medical images and provide a sound opinion or diagnosis on the basis of the medical images. Alternatively, the processor 84 of the server 150 may execute software stored in memory 86 that utilizes optical character recognition (OCR) to translate images of typewritten text on the medical images into machine-editable text. In this manner, if a health care professional included notes or annotations on the medical images (for example in the DICOM format) identifying the anatomical parts (e.g., lungs, heart, etc.) of the human body that are shown in the medical images, the processor 84 is able to identify a qualified physician by examining the profiles of the registered physicians in the manner discussed above. For instance, if the processor uses OCR and determines that the image relates to a visual representation of breasts, the processor is capable of identifying all of the registered mammography radiologists that are registered with the site. Similarly, if the processor uses OCR and determines that the image relates to a visual representation of bones, joints or muscles, the processor is capable of identifying all of the registered musculosketal radiologists that are registered with the website and if the processor uses OCR to determine that the image relates to visual representations of infants, children, or adolescents, the processor is capable of identifying all pediatric radiologists that are registered with the site.

Referring now to FIG. 4 a list of physicians that may be provided to the subscriber is provided. In this regard, the processor is able to provide a list of identified physicians, in the manner discussed above, to the subscriber via the site which may be shown on a display 80 of an electronic device (e.g., electronic device 100) of a subscriber. On the other hand, it should be pointed out that the processor of the server typically will not include physicians in the list that are unqualified to read a particular medical image such as for example if the physician is not qualified to read a nuclear medicine image(s) or a nuclear medicine study. As another example, as it relates to medical images of breasts, the processor of the server typically will not include physicians in the list who are not qualified to read breast images or a breast study in any modality. The list of identified physicians is available to provide the subscriber with a second opinion or diagnosis with respect to medical images based on an evaluation of the medical images and associated reports, analysis or opinions provided a previous physician.

In an exemplary embodiment, the processor of the server is configured to send each of the physicians in the list a message (e.g., e-mail message or short message service (SMS) message, e.g., a text message) containing information that indicates that a subscriber is requesting a second or subsequent reading of medical images and associated data such as corresponding reports, annotations included on the images or opinions, etc. and that the subscriber desires a second or subsequent opinion or diagnosis. The processor of the server 84 is able to determine the first physician to respond to the message which contains information that he/she is willing to provide the subscriber with the second opinion/diagnosis regarding the medical images and associated data, and assigns the first physician to respond with the service of performing the second opinion/diagnosis. The first physician may respond to the message by replying to the message (e.g., replying via e-mail or replying to the SMS message). The electronic device (e.g., electronic device 110) of the first physician to respond may receive a message from the processor of the server 150 indicating that he/she is assigned the service of performing the second opinion/diagnosis requested by the subscriber. Each of the electronic devices of the other physicians in the list may receive a message from the processor of the server indicating that the subscriber's request has been assigned and may specify which physician was assigned the service of performing the second opinion/diagnosis requested by the subscriber.

In an alternative exemplary embodiment, the physicians registered with the website may utilize a corresponding electronic device (e.g., electronic device 120) to log in to a portal or the like, such as a secure web-based portal, associated with the site, in which case each of the physicians in the list are able to receive a message such as an e-mail message that is sent by the processor of the server 150 and is in an inbox that is accessible by all of the physicians in the list that are logged in to the portal. In this regard, a physician may log in to the portal when he/she is interested in performing second or subsequent reads and opinions/diagnosis of medical images and associated data. The message indicates that there is a request by a subscriber(s) for a second opinion or diagnosis regarding the medical images and associated data that is sent or uploaded to the server by the subscriber. The processor 84 of the server 150 is able to determine the first physician in the list to respond to the e-mail message and accept the subscriber's request for providing a second opinion or diagnosis of the medical images and any related data sent or uploaded to the server by the subscriber. The processor of the server is able to send an e-mail message to the inbox of the portal that is accessible to each of the physicians in the list and which identifies the first physician to respond and indicates that this physician is assigned to provide the second opinion/diagnosis of the medical images and associated data requested by the subscriber. Once the first physician is assigned to provide the second opinion/diagnosis of the medical images and associated data to the subscriber, the processor of the server begins a time period during which the first physician must perform the services. If the processor of the server does not receive an indication such as a message (e.g., e-mail message, SMS message, etc.) from the electronic device of the first physician that the subscriber's request is complete by the expiration of this time period, the subscriber's request is reassigned to another physician, so on and so forth. For instance, the processor of the server reassigns the subscriber's request to the second physician that agreed to provide the second or subsequent read of the medical images and associated data.

It should be pointed out that a physician may modify his/her profile during periods in which the physician would not be able to provide the second opinion/diagnosis of the medical images and associated data such as for example when the physician is on vacation and/or his/her schedule does not permit second opinions or diagnoses for a particular reason (e.g., busy workload). In this regard, although the physician meets the qualifications to provide the subscriber with a second or subsequent reading and opinion/diagnosis regarding medical images and associated data, the physician modifying his/her profile to indicate unavailability is not included in the list of physicians that are presented to the subscriber.

While in the foregoing exemplary embodiments, a physician may be assigned based on the first physician to respond to a subscriber's request, assignment of a physician may occur in other ways without departing from the spirit and scope of the invention. For instance, as shown in FIG. 4, the subscriber may select an option on the website to select a physician from the list of physicians and the processor 84 of the server 150 may send the electronic device (e.g., electronic device 100) of the selected physician a message (e.g., e-mail, SMS message, etc.) requesting that this selected physician perform a second or subsequent reading of medical images and associated data. The selected physician may utilize an electronic device to either accept or reject the subscriber's request via a return message such as for example, a reply to the subscriber's e-mail or SMS message. In this regard, it is possible for a subscriber to select a physician based on specific interests such as qualifications, location, reputation or any other suitable aspect.

In the above situations, by agreeing to perform the second opinion/diagnosis, the assigned physician or selected physician may perform the second opinion/diagnosis pertaining to the medical images and associated data on a fixed fee basis (e.g., $100.00, etc.). In this regard, the subscriber's payment method (e.g., credit card, debit card, PayPal™, etc.) would be charged for the services provided by the physician. However, if the subscriber selects a lowest bid option on the site, (see FIG. 4) each of the physicians in the list are able to utilize their electronic devices to send the subscriber a message (e.g., e-mail, SMS message, etc.) indicating a bid or monetary amount (e.g., price/cost) in which he/she will perform the second or subsequent reading of the medical images and associated medical data to provide a second or subsequent opinion or diagnosis. In this regard, the subscriber can open the messages sent from the physicians and view the monetary amount indicated in the messages using a display 80 of the electronic device and select a physician to perform the second or subsequent diagnosis or opinion pertaining to the medical images based on the amount specified in the message. For instance, the subscriber may utilize the processor 84 of his/her electronic device to send the electronic device of a particular physician a message (e.g., e-mail, SMS message, etc.) indicating that he/she accepts the amount specified by the physician. In this regard, the subscriber is able to select the lowest bid or price for performing the additional reading of the medical images and associated data and for providing a second or subsequent opinion/diagnosis regarding the medical images. Additionally, these messages may be accessible by utilizing the pointing device of the user input interface to select the messages menu of the website 7.

It should be pointed out however, that a subscriber may select a physician based on a combination of the proposed amount for the services rendered as well as the qualifications or credentials of the physician or any other suitable attributes or qualities, which may not necessarily consist of the lowest price offered by all of the physicians although price may be a consideration. Subscriber ratings serve as an example of other suitable attributes or qualities that the subscriber may take into consideration in addition to the amount/price of the proposed service to be rendered or qualifications and credentials of the physicians. In this regard, the website is capable of having one or more web pages accessible via the online reviews tab (see FIGS. 3-4) which allow the subscribers to provide comments on and rate each of the physicians' service. These ratings and comments can be used as a factor, among others, (e.g., price, qualifications, credentials, etc.) by a subscriber to determine if he/she wants to select a particular physician. For instance, each physician may be rated on a scale from 1 to 10 and the higher the number the better the rating. Also, comments indicating that subscribers have been satisfied with a physician's services will tend to weigh more favorably than those that indicate that physician's services were inferior. The ability to rate each physician and provide comments regarding each physician may be beneficial given that it may be difficult for subscribers to select a physician on the basis of qualifications or credentials alone and given the medical expertise required to read these medical images and associated data such as annotations, reports, measurements, opinions, etc.

After the subscriber selects the physician, taking into account the amount/price in which the physicians are willing to provide the second or subsequent opinion/diagnosis of medical images and associated data, by sending the respective physician the message in the manner discussed above, the processor of the server may send each of the electronic devices of the other physicians a message indicating that a physician was assigned to handle the subscriber's request. Alternatively, the processor of the server may send a message to the common inbox of the portal that is accessible to each of the physicians making a bid, in which the message indicates that a physician was assigned to handle the subscriber's request.

In an alternative exemplary embodiment, if the subscriber selects a lowest bid option on the site, the subscriber is able to generate a request and specify in a field of the site, for example, that they are willing to pay a specified amount of money (e.g., $140.00) for a second or subsequent read and opinion/diagnosis regarding medical images and that the subscriber desires to have their request completed during a particular time period (e.g., 48 hrs.). The information in the request is kept confidential and typically is not provided to the physicians in the list. The processor of the server 150 managing the website may then send each of the electronic devices of the physicians in the list a message indicating that a subscriber would like a second or subsequent read and corresponding opinion/diagnosis regarding medical images. The message sent to the physicians in the list may also request the physicians to reply or respond to the message (e.g., e-mail or SMS message) with a bid or price specifying an amount of money (e.g., $150.00) in which they are willing to provide the second or subsequent read and opinion/diagnosis of the medical images if they are interested. The physicians in the list may reply or respond to the message by sending an e-mail message, SMS message, etc. to an address linked to the site or by selecting a menu, button, folder or the like and specifying the bid in an associated field. The processor of the server managing the site evaluates the bid or price submitted by each of the physicians in the list and when a time period elapses, (e.g., 24 hrs.) the processor of the server assigns the physician with the lowest bid (e.g., $100.00) the task of performing the second or subsequent read and opinion/diagnosis regarding the medical images provided that the specified amount of money was equal to or below the maximum threshold set by the subscriber (e.g., $140.00).

In a manner analogous to that discussed above, once the subscriber selects or the processor assigns the physician (also referred to herein as assigned or selected physician or selected or assigned physician) that he/she desires to provide the second opinion/diagnosis of the medical images and associated data, the processor of the server begins a time period during which the selected or assigned physician must perform the services. If the processor 84 of the server 150 does not receive an indication such as a message (e.g., e-mail message, SMS message, etc.) from the electronic device of the selected or assigned physician that the subscriber's request is complete by the expiration of this time period, the subscriber may select another physician from the list of available and qualified physicians. Alternatively, the processor of the server may automatically reassign the subscriber's request to another physician, so on and so forth. For instance, the processor of the server may reassign the subscriber's request to the physician that agreed to provide the second or subsequent read and opinion or diagnosis of the medical images at the second lowest cost among all of the physicians providing the subscriber with a bid.

Once the physician is assigned or selected to provide the second read and opinion/diagnosis of the medical images and associated data according to any of the above mechanisms, the processor of the server retrieves the corresponding medical images and associated data that were sent or uploaded by the subscriber and which were stored in memory 86 of the server and the processor of the server sends the medical images and associated data to the electronic device (e.g., electronic device 130) of the assigned or selected physician. The processor of the server may send the electronic device of the assigned or selected physician the medical images and associated data in a message such as for example an e-mail message, a SMS message or the like. Alternatively, the assigned or selected physician may log in to the site and access a menu, button, folder or the like such as the medical images/reports menu (see FIGS. 3-4) on the site via the pointing device of the user input interface or the like and download the medical images and associated data from the memory of the server and store this data to a memory of the physician's electronic device. The assigned or selected physician is able to view the medical images and associated data using the display 80 of an electronic device by accessing the medical images and associated data according to any suitable mechanism. Additionally, the assigned or selected physician may print the medical images and associated data using a printer (not shown) that may be connected to the communication interface(s) 88 of the electronic device. In this regard, the assigned or selected physician may evaluate the medical images which may consist of one or more anatomical parts of the human body and evaluate comments, opinions/diagnosis, reports, measurements, annotations and the like generated by a previous physician that evaluated a patient.

The assigned or selected physician may provide his/her own independent assessment of the medical images which may agree with the previous physician's opinion/diagnosis or may alternate or deviate from the previous physician's opinion/diagnosis. For instance, the previous physician's opinion/diagnosis could be, for example, that a patient's knee has torn ligaments whereas the assigned or selected physician's opinion/diagnosis could be, for example, that the patient's ligaments are sprained as opposed to being torn. The assigned or selected physician may utilize the keyboard or keypad of the user input interface 82 of his/her electronic device (e.g., electronic device 100) to generate his/her second or subsequent opinion/diagnosis regarding the medical images and associated data. This second or subsequent opinion/diagnosis may be in the form of a report that may optionally be in a file that is accessible by the electronic device or another computing device when executed by a processor such as the processor 84 of the electronic device (e.g., electronic device 130). The report may be generated in a format conforming to the Health Level Seven (HL7) protocol which is a standard and a framework for exchanging, sharing and retrieving electronic health information.

In addition, the physician that is assigned by the site, via the processor of the server or selected by the subscriber, to provide the second or subsequent read and opinion/diagnosis regarding the medical images and associated data may utilize the keyboard, keypad or pointing device (e.g., mouse) of the user input interface 82 to generate comments, annotations or measurements that may be super-imposed, overlaid or placed directly on the medical images. For purposes of illustration only and not of limitation, the assigned or selected physician may utilize a software application that is being executed by a processor of the corresponding electronic device to place a marker such as an arrow on a particular area of one or more of the medical images. For example, if the assigned or selected physician identifies something that is difficult to see and hard to find on a medical image, the physician may put a marker such as for example an arrow in this area. In this manner, the assigned or selected physician can mark an area in the medical image for a follow up assessment or can place a marker in the area of the image to serve as a reference to the image during a discussion in the report so that the subscriber can easily identify exactly what area the physician is describing on the medical image(s). As an example, if there is an area of tissue or cells that has an infiltration and the assigned or selected physician places a marker in the corresponding area on a medical image(s), when the subscriber reads the physician's report he/she can identify where the infiltration is located on the image, such as for example in the upper right quadrant.

As described above, the assigned or selected physician can utilize the keyboard, keypad, pointing device or the like of the user input interface 82 of the electronic device to generate one or more measurements that can be overlaid on one or more medical images. For purposes of illustration and not of limitation, if the physician finds a nodule that appears to be unusually dense in one or more of the medical images, the physician may take a density measurement because the density measurement provides an understanding of how dense the nodule is relative to a standard like air or water. This measurement may be overlaid or super-imposed directly on the corresponding area of the medical image(s) and may be referred to in the contents of the report, which makes the contents of the report easier to follow for the subscriber or any other person reviewing the report of the medical images. Any other suitable measurements may be overlaid or super-imposed on one or more of the medical images, for instance, the assigned or selected physician may take a different measurement to determine the thickness of one or more anatomical parts of the human body. This could be of benefit in instances in which the patient has previously had successive medical examinations and is trying to access whether cells or tissue are benign, for example.

Overlaying or super-imposing comments, annotations, measurements and the like on the medical image(s) along with the assigned or selected physician's report enables the physician to indicate their findings in a manner that is useful to the patient so that the subscriber, or any other person, can more easily understand what the physician is discussing or referring to in the report. For instance, not only is overlaying or super-imposing the comments, annotations, measurements, etc. directly on the medical images beneficial to the subscriber, but may also be beneficial to other physician's that review the report and medical images containing any overlaid information that was generated by the assigned or selected physician that provided the subscriber with the second or subsequent read and opinion/diagnosis pertaining to the medical images. For instance, if the subscriber is a patient, he/she could share the report and the medical images with a primary care physician or the physician performing a first or previous reading and opinion/diagnosis pertaining to the medical images, which may be beneficial in explaining the differences in the initial or previous opinion/diagnosis.

Once the assigned or selected physician completes the report and overlays or super-imposes any comments, annotations, measurements and the like on the medical image(s), the assigned or selected physician may utilize an electronic device to send the report and one or more medical images containing the overlaid or super-imposed information in a message to the subscriber in a message. For instance, the processor of the assigned or selected physician's electronic device may send the subscriber a message such as, for example, an e-mail message containing the report and the medical images with the overlaid or superimposed information placed directly on respective areas of a medical image(s). Alternatively, the processor of the assigned or selected physician's electronic device can be used to upload the report and the one or more medical images containing any comments, annotations, measurements or the like overlaid or superimposed on the medical images to the website by accessing the medical images/reports menu of the website for example. When the assigned or selected physician providing the second or subsequent read and opinion/diagnosis of the medical images uploads the report and the medical images to the site, the processor of the server 150 may automatically send the electronic device of the subscriber a message (e.g., an e-mail message, a SMS message, etc.) indicating that the report and the medical images with any overlaid information is complete and is available for download. In this regard, the subscriber may log or sign in to the site and utilize the pointing device or the like of the user input interface to select a menu, folder or the like indicating that the report and any associated medical images are available and download the report and the medical images to a memory of his/her electronic device (e.g., electronic device 110).

It should be pointed out that when the assigned or selected physician either sends the subscriber the message (e.g., e-mail message or SMS message) with the medical report and any medical images which may contain overlaid or super-imposed information or when the assigned or selected physician uploads the medical report and the medical images to the site, the processor of the server 150 charges the account (e.g., credit card, debit card, PayPal™, etc.) of the subscriber the monetary amount for the services rendered in performing the second or subsequent read and opinion/diagnosis regarding the medical images.

The subscriber could repeat the foregoing process if more than a second read and opinion/diagnosis of the medical images is desired. For instance, if the subscriber was not satisfied with a second read, the subscriber could obtain a third, fourth, etc. read of medical images and a corresponding opinion/diagnosis from other physicians.

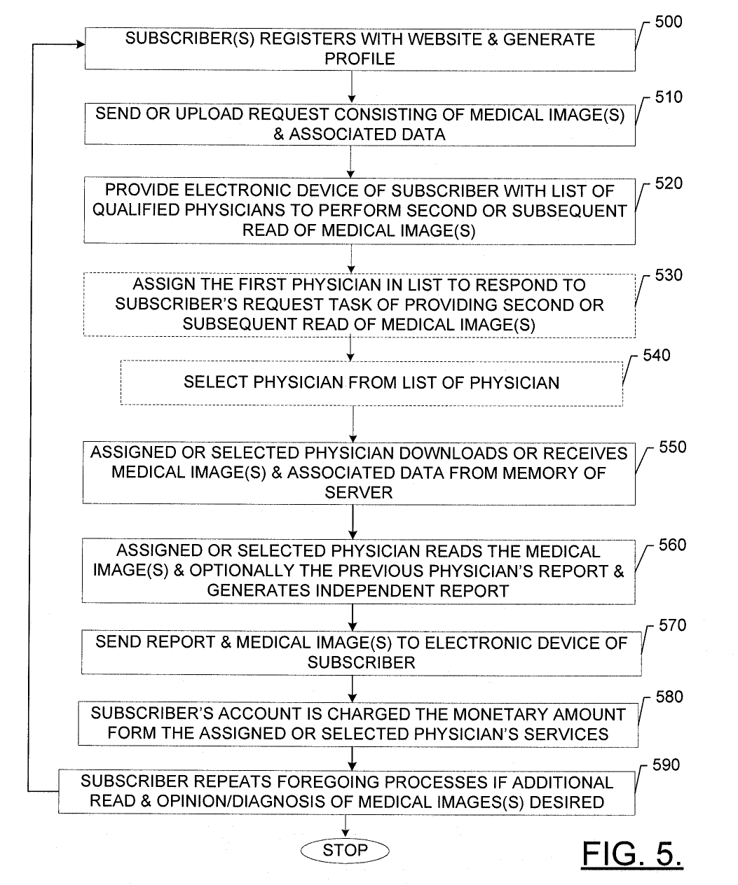

Referring to FIG. 5 a flowchart for illustrating a mechanism of receiving a second or subsequent read and opinion/diagnosis regarding medical images is provided. At operation 500, one or more subscribers register with the website 7 and generate a profile. At operation 510, a subscriber interested in obtaining a second or subsequent read and opinion/diagnosis of medical images and associated data generated by a previous physician may send or upload a request consisting of the medical images and associated data to a memory of a server 150 associated with the site 7, in the manner discussed above. In this regard, the medical images and associated data are accessible via the site. At operation 520, a processor of the server may provide the electronic device of the subscriber with a list of physicians that are qualified to perform the second or subsequent read and opinion/diagnosis regarding the medical images and associated data. This list of physicians may be provided to the display of the subscriber's electronic device and may consist of, in one embodiment, a web page of the website as shown in FIG. 4. Optionally, at operation 530, the processor of the server may assign the first physician in the list of physicians to respond to the subscriber's request the task of providing the second or subsequent read and opinion/diagnosis regarding the medical images and associated data. Optionally, at operation 540, the subscriber may utilize his/her electronic device to select a particular physician in the list of physicians. It should be pointed out that processor of the electronic device performs the selection of the physician from the list. This selection may be based on one or more bids provided by the physicians to the subscriber as well as any other factors such as specialties, qualifications and the like of the physicians.

At operation 550, the assigned or selected physician downloads from the site or receives the medical images and associated data from the memory of the server and stores the medical images and associated data in a memory of his/her electronic device. At operation 560, the assigned or selected physician reads the medical images and optionally the previous physician's report, opinion/diagnosis and other associated data and generates an independent report regarding the second or subsequent read of the medical images and may overlay or super-imposed any associated comments, annotations or measurements directly on one or more of the medical images in a manner analogous to that discussed above. At operation 570, the report and the medical images containing any overlaid or super-imposed comments, measurements or annotations may be sent by the electronic device of the assigned or selected physician in a message (e.g., e-mail message or SMS message, etc.) to the subscriber or alternatively may be uploaded to the website in which case the processor of the server automatically sends the electronic device of the subscriber a message indicating that the second or subsequent opinion/diagnosis concerning the medical images is completed and is available for download. At operation 580, the subscriber's account is charged the monetary amount for the assigned or selected physician's services. Optionally at operation 590, the subscriber may repeat the process in operations 500-580 if he/she desires an additional read and opinion/diagnosis of medical images that were previously analyzed by another physician.

It should be understood that each block or step of the flowchart shown in FIG. 5 and combination of blocks in the flowchart, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a processor in the electronic device and/or the network entities, e.g., server. As will be appreciated, any such computer program instructions may be loaded onto a computer or other programmable apparatus (i.e., hardware) to produce a machine, such that the instructions which execute on the computer or other programmable apparatus (e.g., hardware) means for implementing the functions implemented specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the functions specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions that are carried out in the system.

The above described functions may be carried out in many ways. For example, any suitable means for carrying out each of the functions described above may be employed to carry out the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

By utilizing the exemplary embodiments of the invention, any patient or subscriber has a mechanism in which to request a qualified independent second or subsequent read of one or more medical images and associated opinions/diagnoses that was that originally performed by a previous physician. Additionally, physicians, such as for example, radiologists, cardiologists, etc. wishing to offer second read services can do so with confidence that they will be paid for their time and expertise.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

For instance, in an alternative exemplary embodiment, as shown in FIG. 3, the subscriber may select a menu, (e.g., blind read menu) button, folder or the like on the site requesting a blind read of the medical images that he/she uploaded or sent to the server, in which case the medical images are made available to the selected or assigned physician, (in the manner discussed above) but not the prior physician's reports, annotations, measurements, opinions/diagnosis, i.e., the associated data. In this regard, the selected or assigned physician may provide an independent second or subsequent opinion/diagnosis regarding a reading of the medical images that is not influenced by a prior physician's opinion/diagnosis regarding the medical images and this second or subsequent opinion/diagnosis may be provided to the subscriber in the manner discussed above. Also, the cost associated with performing this blind read may generally be more than those in which physicians have access to the medical reports, annotations, measurements and, opinion/diagnosis, i.e., the associated data generated by the previous physician, because more work is involved and it will generally take longer to complete the second opinion/diagnosis without reviewing the prior physician's reports, opinions and diagnosis.

That which is claimed:

1. A method, comprising:
receiving one or more medical images and associated data that was initially evaluated by a previous medical care provider;
assigning or selecting a medical care provider from among one or more candidate medical care providers to provide a second or subsequent reading of the medical images and associated data;
sending the medical images and associated data to a first device associated with the selected medical care provider; and
receiving a second or subsequent medical opinion or diagnosis regarding the medical images based upon an evaluation of the medical images and associated data by the selected medical care provider.

2. The method of claim 1, further comprising overlaying or super-imposing at least one of comments, annotations and measurements directly on at least one of the medical images to generate one or more annotated medical images.

3. The method of claim 2, further comprising,
automatically charging an account of a subscriber an amount of money for generating the second or subsequent medical opinion; and
sending the second or subsequent medical opinion or diagnosis and the annotated medical images to a second device associated with or designated by the subscriber.

4. The method of claim 3, wherein prior to sending the second or subsequent medical opinion automatically providing the subscriber with an indication that the annotated medical images and the second or subsequent medical opinion or diagnosis is completed and is accessible by the subscriber.

5. The method of claim 1, wherein the assigning comprises assigning a first physician, among the physicians, to respond to a subscriber's request for performing a second or subsequent reading of the medical images and generating a corresponding opinion or diagnosis regarding the reading of the medical images.

6. The method of claim 1, wherein selecting comprises selecting the physician among the physicians based on receipt of one or more messages from at least one of the one or more physicians specifying an amount of money for which the at least one physician agrees to perform a second or subsequent reading of the medical images and generate a corresponding opinion or diagnosis regarding the reading of the medical images.

7. The method of claim 6, further comprising determining which messages indicate a lowest amount of money and selecting the physician, at least in part, based on the lowest amount of money.

8. The method of claim 1, further comprising, receiving a rating of at least one of the one or more physicians on the basis of quality of service and wherein selecting comprises selection of the physician, at least in part, based on the rating.

9. The method of claim 1, further comprising determining that each candidate medical care provider is qualified and expressed an interest in performing a second or subsequent reading of the medical images and generating a corresponding opinion or diagnosis regarding the reading of the medical images.

10. The method of claim 1, further comprising determining that the associated data comprises information relating to at least one of a report, annotations, measurements, opinion or diagnosis, relating to the medical images, that was generated by the previous physician.

11. The method of claim 10, wherein the second or subsequent reading of the medical images is performed and a corresponding opinion or diagnosis regarding the reading of the medical images is generated without viewing or considering the associated data.

12. The method of claim 10, wherein the second or subsequent reading of the medical images is performed and a corresponding opinion or diagnosis regarding the reading of the medical images is generated only on the basis of the medical images.

13. The method of claim 1, further comprising, reassigning or selecting another physician from the list when the physician does not generate the second or subsequent medical opinion or diagnosis regarding the medical images within a predetermined amount of time.

14. The method of claim 1, wherein the selecting comprises receipt of one or more messages from at least one of the one or more physicians within a predetermined amount of time, the messages specify an amount of money in which the at least one physician agrees to generate the second or subsequent medical opinion or diagnosis regarding the medical images, and upon expiration of the predetermined amount of time, automatically selecting the physician specifying a lowest amount of money.

15. An apparatus, comprising a processor configured to:
receive one or more medical images and associated data that was initially evaluated by a previous medical care provider;
assign or select a medical care provider from among one or more candidate medical care providers to provide a second or subsequent read of the medical images and associated data;
send the medical images and associated data to a first device associated with the selected medical care provider; and
receive a second or subsequent medical opinion or diagnosis regarding the medical images based upon an evaluation of the medical images and associated data by the selected medical care provider.

16. The apparatus of claim 15, wherein the processor is configured to generate by overlaying or super-imposing at least one of comments, annotations and measurements directly on at least one of the medical images to generate one or more annotated medical images.

17. The apparatus of claim 16, wherein the processor is further configured to:
automatically charge an account of a subscriber an amount of money for generating the second or subsequent medical opinion; and
send the second or subsequent medical opinion or diagnosis and the annotated medical images to a second device associated with or designated by the subscriber.

18. The apparatus of claim 17, wherein the processor is further configured to automatically provide the subscriber with an indication that the annotated medical images and the second or subsequent medical opinion or diagnosis is completed and is accessible by the subscriber.

19. The apparatus of claim 15, wherein the processor is configured to assign by assigning a first physician, among the physicians, to respond to a subscriber's request for performing a second or subsequent reading of the medical images and generating a corresponding opinion or diagnosis regarding the reading of the medical images.

20. The apparatus of claim 15, wherein the processor is configured to select by selecting the physician among the physicians based on receipt of one or more messages from at least one of the one or more physicians specifying an amount of money for which the at least one physician agrees to perform a second or subsequent reading of the medical images and generate a corresponding opinion or diagnosis regarding the reading of the medical images.

21. The apparatus of claim 20, wherein the processor is further configured to determine which messages indicate a lowest amount of money and select the physician, at least in part, based on the lowest amount of money.

22. The apparatus of claim 15, wherein the processor is further configured to evaluate one or more received ratings of at least one of the one or more physicians on the basis of quality of service and wherein select comprises selection of the physician, in part, based on the ratings.

23. The apparatus of claim 15, wherein the processor is further configured to determine that each candidate medical care provider is qualified and expressed an interest in performing a second or subsequent reading of the medical images and generating a corresponding opinion or diagnosis regarding the reading of the medical images.

24. The apparatus of claim 15, wherein the processor is further configured to determine that the associated data comprises information relating to at least one of a report, annotations, measurements, opinion or diagnosis, relating to the medical images, that was generated by the previous physician.

25. A computer program product, the computer program product comprising at least one computer-readable storage medium having computer-readable program code portions stored therein, the computer-readable program code portions comprising:
a first executable portion for receiving one or more medical images and associated data that was initially evaluated by a previous medical care provider;
a second executable portion for assigning or selecting a medical care provider from among one or more candidate medical care providers to provide a second or subsequent reading of the medical images and associated data;
a third executable portion for sending the medical images and associated data to a first device associated with the selected medical care provider; and
a fourth executable portion for receiving a second or subsequent medical opinion or diagnosis regarding the medical images based upon an evaluation of the medical images and associated data by the selected medical care provider.
